(19) United States
(12) Patent Application Publication
(10) Pub. No.: US 2021/0073258 A1
(43) Pub. Date: Mar. 11, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Seiya INAGI, Kanagawa (JP); Takafumi SUZUKI, Kanagawa (JP); Dai TAKESHIMA, Kanagawa (JP); Soma SHIRAKABE, Kanagawa (JP)

(73) Assignee: FUJI XEROX CO., LTD., Tokyo (JP)

(21) Appl. No.: 16/830,917

(22) Filed: Mar. 26, 2020

(30) Foreign Application Priority Data
Sep. 10, 2019 (JP) 2019-164278

(51) Int. Cl. G06F 16/36; G06F 40/30; G06F 40/242; G06F 40/284; G06F 16/35

(52) U.S. Cl. CPC G06F 16/367; G06F 40/30; G06F 16/35; G06F 40/284; G06F 40/242

(57) ABSTRACT

An information processing apparatus includes a processor. The processor is programmed to output, by performing clustering on vocabulary information, vocabulary classification information representing a classification of an existing ontology that is systematically represented by linking plural concepts. The vocabulary information is produced from text information not classified into the existing ontology. The vocabulary information represents a semantic correlation of a vocabulary. The clustering uses concept classification information that is produced in accordance with an inheritance relation between the concepts included in the existing ontology and that is indicated as a pair of a concept as an inheritance source and a concept as an inheritance destination. The processor is programmed to then extend the existing ontology by adding to the existing ontology a concept absent in the existing ontology by using the vocabulary classification information.

### CROSS-REFERENCE TO RELATED APPLICATIONS

This application is based on and claims priority under 35 USC 119 from Japanese Patent Application No. 2019-164278 filed Sep. 10, 2019.

### BACKGROUND

### (i) Technical Field

The present disclosure relates to an information processing apparatus and a non-transitory computer readable medium.

### (ii) Related Art

Japanese Unexamined Patent Application Publication No. 2007-199885 discloses a data structure of an ontology and an information analysis knowledge management apparatus that uses the ontology. The data structure of the ontology provides a higher efficiency in description and processing to the writer of a dictionary and a program that extracts and classifies information and is easy to understand for the writer and the program. The information analysis knowledge management apparatus includes an ontology memory that stores an ontology having a hierarchical structure having at least three hierarchies and a registration and edit unit that registers the ontology onto the ontology memory or edits the ontology. The information analysis knowledge management apparatus further includes a dictionary producing unit, a first dictionary memory, and a second dictionary memory. The dictionary producing unit produces a first dictionary for use in information extraction or information classification from a hierarchical portion of a first range including a top-most hierarchy of the ontology and further produces a second dictionary for use in information extraction or information classification from a hierarchical portion of a second range that shares at least one hierarchy with the hierarchical portion of the first range. The first dictionary memory stores the first dictionary. The second dictionary memory stores the second dictionary.

Japanese Unexamined Patent Application Publication No. 2016-162054 discloses an ontology producing apparatus that produces knowledge structure data that defines a system of metadata that is commonly usable at multiple contents. The ontology producing apparatus includes a caption extraction unit, word extraction unit and structuring unit. The caption extraction unit extracts hierarchy information of a caption from multiple pieces of document information in a specified field. The word extraction unit extracts a word tied to the caption from the document information. Based on the degree of similarity of each word, the structuring unit combines captions and produces the knowledge structure data in a field including the hierarchy information of the captions combined.

Japanese Unexamined Patent Application Publication No. 2014-056591 discloses a method that is implemented by a computer and performs facet analysis on input information that is selected from a domain of information in accordance with a source data structure. The method includes a step of accessing to one or more pattern increases and one or more statistical analyses by one or more computer processors or of facilitating the accessing by one or more computer processors, a step of applying one or more pattern increases and one or more statistical analyses to input information by one or more computer processors or of identifying a pattern in a facet attribute relation by facilitating the application to the input information by one or more computer processors, and a step of finding at least one of a facet of information, a facet attribute, and a facet attribute hierarchy by one or more computer processors or of facilitating the finding in the input information by one or more computer processors.

A manually produced existing ontology is guaranteed a higher product quality. On the other hand, however, a large amount of manpower may be involved to extend the existing ontology. The extension of the existing ontology is desirably automatically performed.

### SUMMARY

Aspects of non-limiting embodiments of the present disclosure relate to providing a non-transitory computer readable medium and an information processing apparatus that supports automatic extension of the existing ontology.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a processor. The processor is programmed to, output by performing clustering on vocabulary information, vocabulary classification information representing a classification of an existing ontology that is systematically represented by linking a plurality of concepts. The vocabulary information is produced from text information not classified into the existing ontology. The vocabulary information represents a semantic correlation of a vocabulary. The clustering uses concept classification information that is produced in accordance with an inheritance relation between the concepts included in the existing ontology and that is indicated as a pair of a concept as an inheritance source and a concept as an inheritance destination. The processor is programmed to then extend the existing ontology by adding to the existing ontology a concept absent in the existing ontology by using the vocabulary classification information.

### BRIEF DESCRIPTION OF THE DRAWINGS

Exemplary embodiment of the present disclosure will be described in detail based on the following figures, wherein:

FIG. 1 illustrates an example of an existing ontology of an exemplary embodiment;

FIG. 2 is an electrical block diagram of an information processing apparatus of the exemplary embodiment;

FIG. 3 is a functional block diagram of the information processing apparatus of the exemplary embodiment;

FIG. 4 illustrates an example of a vocabulary network of the exemplary embodiment;

FIG. 5 illustrates a relationship between the existing ontology and an extension ontology in accordance with the exemplary embodiment; and

FIG. 6 is a flowchart of an information processing program of the exemplary embodiment.

### DETAILED DESCRIPTION

An exemplary embodiment of the disclosure is described in detail below with reference to the drawings.

The ontology of the exemplary embodiment refers to a system including multiple concepts linked to each other and falling within a predetermined classification and is data that may be processed by a computer. The ontology of the exemplary embodiment is assumed to be a set of concepts of two or more hierarchies as elements of the ontology. Each concept includes information on (1) concept name and (2) classification of the concept and if possible, further includes information (3) another name of the concept.

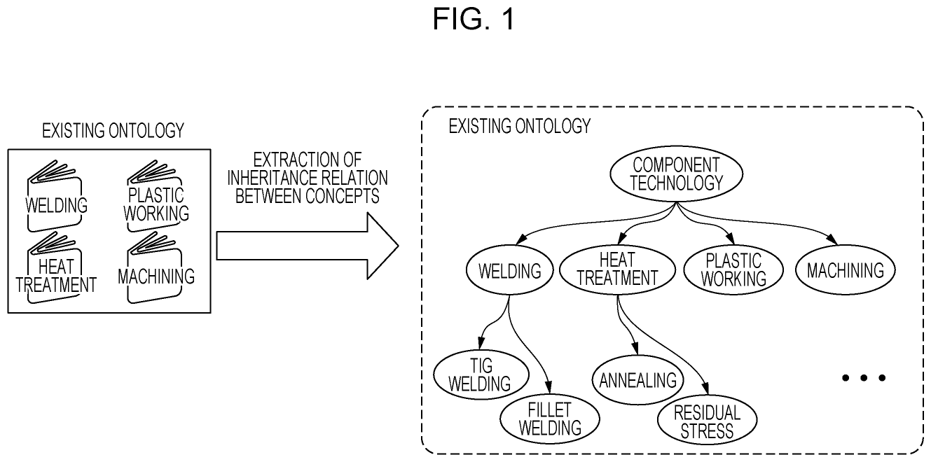

FIG. 1 illustrates an example of the existing ontology of the exemplary embodiment.

The ontology in FIG. 1 is manually produced and used as an input to an information processing apparatus 10. The ontology in FIG. 1 is formed in the manufacturing industry. The ontology includes four categories “welding”, “heat treatment”, “plastic working”, and “machining” subordinate to a higher category “component technology”. The categories “welding”, “heat treatment”, “plastic working”, and “machining” represent respective concepts. The “welding” is further linked with concepts “tungsten insert gas (TIG) welding” and “fillet welding”. The “heat treatment” is further linked with concepts “annealing” and “residual stress”.

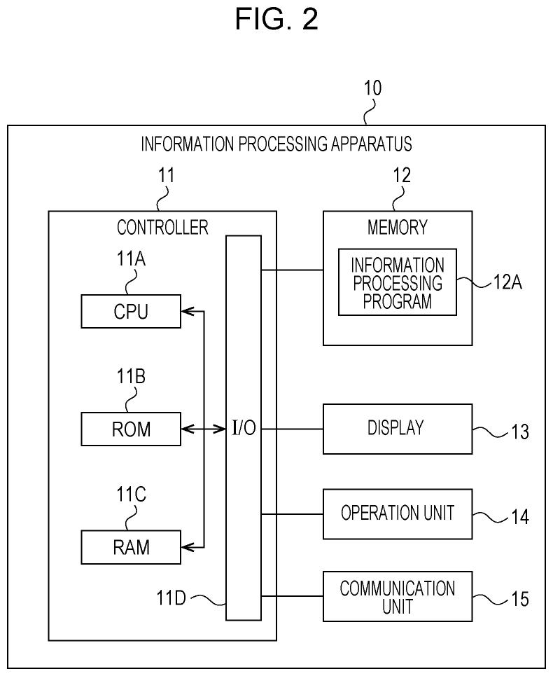

FIG. 2 is an electrical block diagram of the information processing apparatus 10 of the exemplary embodiment.

Referring to FIG. 2, the information processing apparatus 10 of the exemplary embodiment includes a controller 11, memory 12, display 13, operation unit 14, and communication unit 15. The information processing apparatus 10 may be a general-purpose computer, such as a server computer or a personal computer (PC).

The controller 11 includes a central processing unit (CPU) 11A, read-only memory (ROM) 11B, read-only memory (ROM) 11B, random-access memory (RAM) 11C, and input and output interface (I/O) 11D. These elements are interconnected to each other via a bus.

The I/O 11D is connected to elements including the memory 12, display 13, operation unit 14, and communication unit 15. The elements are communicably connected to the CPU 11A via the I/O 11D.

The controller 11 may be configured to control part or whole of the operation of the information processing apparatus 10. All or some of the elements of the controller 11 may be an integrated circuit (IC), such as a large-scale integration (LSI) chip, or an IC chip set. Each element may be an individual circuit or part or whole of each element may be an IC. The elements may be integrated into a unitary body or some of the elements are individually arranged. Part of each of the elements may be separately arranged. The controller 11 is not limited to the LSI chip and may be a dedicated circuit or a general-purpose processor.

The memory 12 may be a hard disk drive (HDD), a solid-state drive (SSD), or a flash memory. An information processing program 12A of the exemplary embodiment is stored on the memory 12. The information processing program 12A may also be stored on the ROM 11B.

The information processing program 12A may be installed beforehand on the information processing apparatus 10. The information processing program 12A may be installed on the information processing apparatus 10 by storing the information processing program 12A on a non-transitory non-volatile storage medium or by distributing the information processing program 12A via a network. Examples of the non-transitory non-volatile storage medium may include a compact disk read-only memory (CD-ROM), magneto-optical disk, HDD, digital versatile disk read-only memory (DVD-ROM), flash memory and memory card.

The display 13 may be a liquid-crystal display (LCD) or an electro-luminescence (EL) display. The display 13 may be combined with a touch panel as a unitary body. The operation unit 14 includes an operation input device, such as a keyboard and a mouse. The display 13 and the operation unit 14 receive a variety of instructions from the user of the information processing apparatus 10. The display 13 displays results of a process performed in response to an instruction from the user and a variety of information including a notification concerning the process.

The communication unit 15 is connected to a network system including the Internet, local-area network (LAN), and/or wide-area network (WAN). The communication unit 15 may communicate with an external apparatus, such as an image forming apparatus or other information processing apparatus, via the network system.

As described above, the manually produced existing ontology is guaranteed a higher product quality. On the other hand, however, a large amount of manpower may be involved. The extension of the existing ontology is desirably automatically performed.

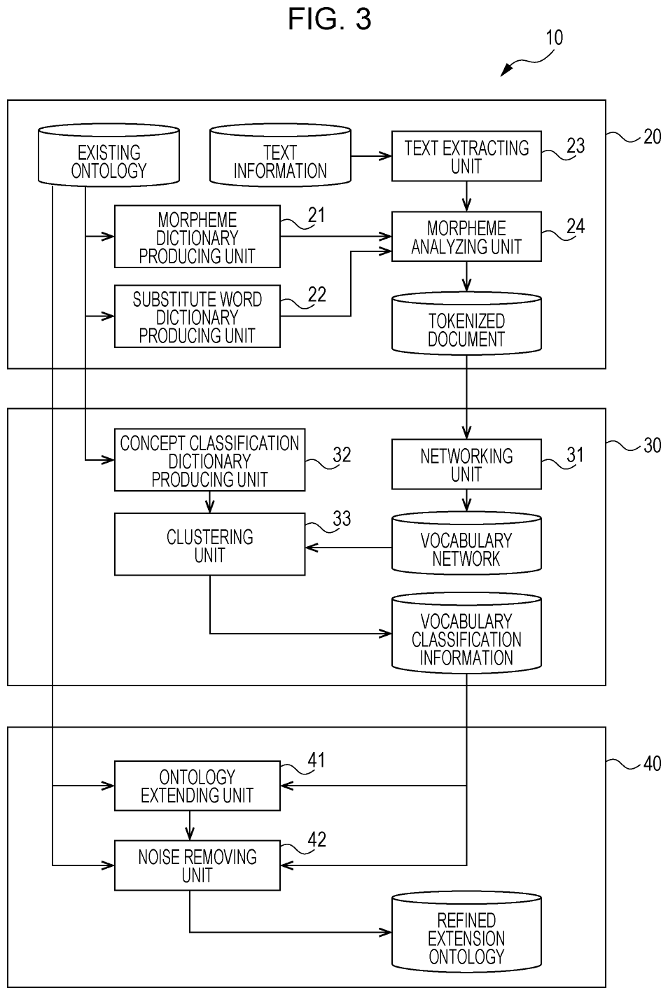

The CPU 11A in the information processing apparatus 10 of the exemplary embodiment functions as the elements in FIG. 3 by reading the information processing program 12A from the memory 12 onto the RAM 11C and then by executing the information processing program 12A. The CPU 11A is an example of a processor.

FIG. 3 is a functional block diagram of the information processing apparatus 10 of the exemplary embodiment.

Referring to FIG. 3, the information processing apparatus 10 of the exemplary embodiment functions as a pre-processing module 20, an information extracting module 30, and an ontology extension processing module 40. With these modules, the CPU 11A outputs, through clustering, vocabulary classification information representing a classification of an existing ontology. The CPU 11A performs the clustering by using concept classification information that is indicated as a pair of a concept of an inheritance source and a concept of an inheritance destination and that is produced in accordance with an inheritance relation between concepts included in the existing ontology with respect to vocabulary information that represents a semantic correlation of a vocabulary and is produced from text information that is not classified in the existing ontology that is systematically represented by linking multiple concepts. With these modules, the processor 11A outputs vocabulary classification information representing a classification of an existing ontology that is systematically represented by linking multiple concepts, by performing clustering on vocabulary information that is produced from text information not classified in the existing ontology and that represents a semantic correlation of a vocabulary, by using concept classification information that is produced in accordance with an inheritance relation between the concepts included in the existing ontology and that is indicated as a pair of a concept of an inheritance source and a concept of an inheritance destination. By using the output vocabulary classification information, the CPU 11A adds to the existing ontology a concept absent in the existing ontology, thereby extending the existing ontology.

The pre-processing module 20 includes a morpheme dictionary producing unit 21, substitute word dictionary producing unit 22, text extracting unit 23, and morpheme analyzing unit 24. The morpheme dictionary producing unit 21, substitute word dictionary producing unit 22, text extracting unit 23, and morpheme analyzing unit 24 are implemented as the function of the CPU 11A. Note that the existing ontology, text information, and tokenized document are stored on the memory 12.

The existing ontology systematically represents multiple concepts by linking the concepts. The existing ontology is displayed as the ontology in FIG. 1. If the concept included in the existing ontology to which each piece of the text information corresponds is unknown, that text information is determined as being not classified as the existing ontology. The text information is a set texts not classified as the existing ontology and, for example, includes multiple files. The existing ontology and the text information are beforehand prepared as input files and may be stored external to the information processing apparatus 10.

The morpheme dictionary producing unit 21 produces, as a morpheme dictionary, a list of words as multiple substitute destinations (for example, concept names) and words as multiple substitute sources (for example, other names), included in the existing ontology.

The substitute word dictionary producing unit 22 produces as a substitute word dictionary a list of pairs, each pair of a word as a substitute destination (for example, a concept name) and a word as a substitute source (for example, another name), included in the existing ontology. The substitute word dictionary is an example of substitute word information including a pair of a word as the substitute destination and a word as the substitute source.

The text extracting unit 23 extracts all texts included in the text information serving a target.

The morpheme analyzing unit 24 morphologically analyzes a text extracted by the text extracting unit 23, by using the morpheme dictionary produced by the morpheme dictionary producing unit 21 and the substitute word dictionary produced by the substitute word dictionary producing unit 22. The morpheme analyzing unit 24 substitutes a morpheme corresponding to another name in the substitute word dictionary by the concept name as the substitute destination. The morpheme analyzing unit 24 may also perform part-of-speech determination at the same time to extract only nouns. A pre-process typical in the field of natural language processing, such as removing stop words, may also be performed. The morpheme analyzing unit 24 outputs a document into which the text is tokenized (hereinafter referred to as a tokenized document) as results of morphological analysis. The output tokenized document is stored as an intermediate file on the memory 12.

The pre-processing module 20 outputs the tokenized document by morphologically analyzing the text extracted from the text information by using the morpheme dictionary and the substitute word dictionary produced from the existing ontology.

The information extracting module 30 includes a networking unit 31, concept classification dictionary producing unit 32, and clustering unit 33. The networking unit 31, concept classification dictionary producing unit 32, and clustering unit 33 are implemented as a function of the CPU 11A. Information on a vocabulary network and vocabulary classification information are stored on the memory 12.

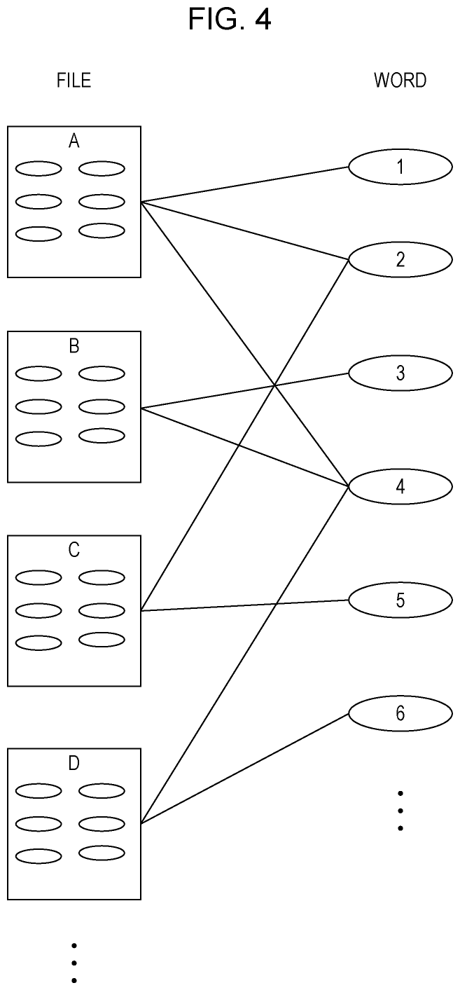

The vocabulary network is an example of vocabulary information representing a semantic correlation of a vocabulary. Specifically, the semantic correlation of the vocabulary is extracted in accordance with a feature of the vocabulary (for example, collocation) in a large-scale text information group. For example, the vocabulary network may be obtained by networking the semantic correlation of the vocabulary as illustrated in FIG. 4.

FIG. 4 illustrates an example of the vocabulary network of the exemplary embodiment.

The vocabulary network in FIG. 4 represents the relationship between each of multiple files (for example, files A, B, C, D, . . . ) and each of multiple words (words 1, 2, 3, 4, 5, 6, . . . ). Each file includes multiple words (one word is denoted by an ellipse in FIG. 4). For example, the file A is linked to words 1, 2, and 4, the file B is linked to words 3 and 4, the file C is linked to words 2 and 5, and the file D is linked to words 4 and 6.

The networking unit 31 produces the vocabulary network in FIG. 4 from the tokenized document and stores the produced the vocabulary network as the intermediate file on the memory 12. Specifically, the networking unit 31 produces a dual network in accordance with a link between a given text unit and a morpheme appearing in the text unit.

The concept classification dictionary producing unit 32 produces as a concept classification dictionary a list of pairs, each pair including a concept serving as an inheritance source and a concept serving as an inheritance destination, in accordance with the inheritance relation between the concepts included in the existing ontology. The concept classification dictionary is an example of the concept classification information that represents a pair of the concept serving as the inheritance source and the concept serving as the inheritance destination. If the existing ontology includes three or more hierarchies, each of all inheritance destinations below a given inheritance source may be set to be a pairing target to the inheritance source.

The clustering unit 33 performs the clustering on the vocabulary network produced by the networking unit 31, by using the concept classification dictionary produced by the concept classification dictionary producing unit 32. As an example of the clustering, the clustering unit 33 performs the clustering with a network restriction. For example, the restriction is that concept names having the same inheritance source in the concept classification dictionary belong to the same cluster. The cluster refers to a group of vocabularies (concepts) having the semantic correlation. Classifying a large number of vocabularies (concepts) into multiple clusters is referred to as clustering. In the clustering, the semantic correlation of the vocabulary (concepts) may be represented by vector data. The clustering of the vector data may be a k-means method, a Gaussian mixture model (GMM) method, or a ward method. If the vocabulary network is used, the clustering method of the network may be a modular decomposition of Markov chain (MDMC) method as described in Japanese Unexamined Patent Application Publication No. 2016-29526, Louvain method, or Infomap method. If the vector data is used, specific example of the clustering with restriction may be a constrained (COP)-kmeans method or a hidden Markov random fields (HMRF)-kmeans method. The clustering unit 33 outputs as the clustering results the vocabulary classification information representing the classification of the existing ontology and stores the output vocabulary classification information as an intermediate file on the memory 12. The vocabulary classification information is data having a classification in the existing ontology of the vocabulary having appeared in the text information.

The CPU 11A may evaluate the degree of importance of each of the files of the text information in terms of the relationship with the existing ontology. The degree of importance of the file may be evaluated by using related art techniques including a personalized page rank method, disclosed in the paper, Glen Jeh and Jennifer Widom, “Scaling Personalized Web Search”, http://infolab.stanford.edu/˜glenj/spws.pdf (accessed May 10, 2019), or the method disclosed in Japanese Unexamined Patent Application Publication No. 2013-168127. In this way, only a file of higher value to the existing ontology from among multiple files is used as a target.

The CPU 11A may evaluate the degree of similarity between multiple files forming the text information. Cosine similarity between indexes indicating the degrees of importance of the files obtained via the method described above may be used to evaluate the degree of similarity of each file. The cosine similarity represents the closeness between angles of vectors. If the cosine similarity is close to 1, the files are determined to be similar and if the cosine similarity is close to 0, the files are determined not to be similar. From among the multiple files, only a file similar to a file of value to the existing ontology is used as a target file.

The CPU 11A may evaluate the degree of similarity between a word appearing in the multiple files forming the text information and a concept included in the existing ontology. Specifically, the CPU 11A determines the degree of similarity between a word in a file forming the text information and a concept of the existing ontology into which the word is classified through the vocabulary classification information. For example, the degree of similarity may be an edit distance of character strings.

The edit distance is also referred to as Levenshtein distance and is a kind of distance indicating how distant two character strings are. Specifically, the edit distance is defined as a minimum count of steps of inserting one character, deleting one character, or substituting one character by another word to change one character string to another character. In this way, from among words appearing in files, a word not similar to a concept included in the existing ontology is thus removed.

The information extracting module 30 outputs the vocabulary classification information by clustering the vocabulary network produced from the tokenized document using a concept classification dictionary.

The ontology extension processing module 40 includes an ontology extending unit 41 and a noise removing unit 42. The ontology extending unit 41 and the noise removing unit 42 are implemented as a function of the CPU 11A. Note that a refined extension ontology (or extended ontology) is stored on the memory 12.

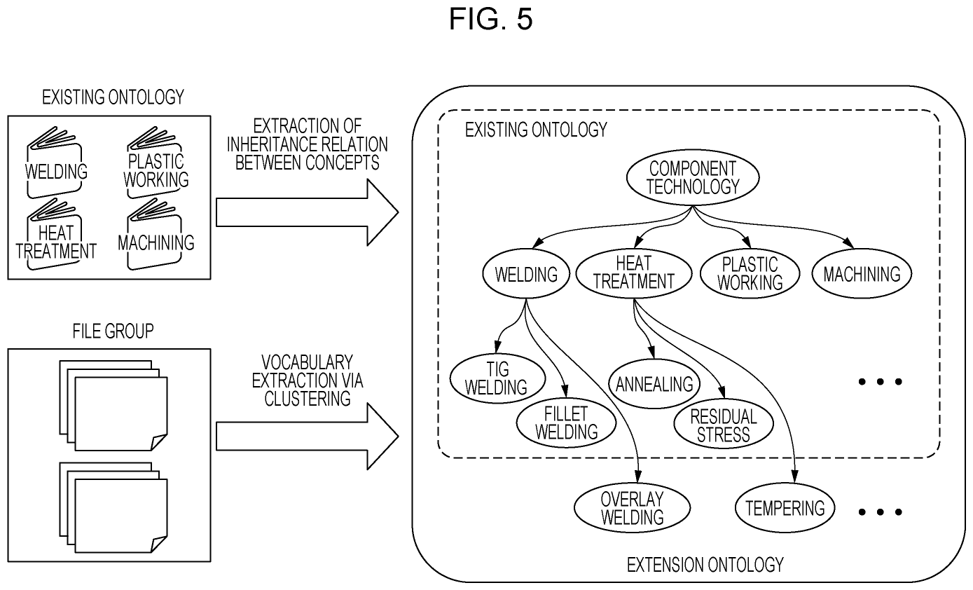

By using the vocabulary classification information, the ontology extending unit 41 adds to the existing ontology a concept absent in the existing ontology, thereby extending the existing ontology as illustrated in FIG. 5. In this case, the concept may be added to multiple classifications. The extended existing ontology is hereinafter referred to as an “extension ontology”.

FIG. 5 illustrates the relationship between the existing ontology and the extension ontology in accordance with the exemplary embodiment.

The extension ontology in FIG. 5 is the existing ontology in FIG. 1 with concepts “overlay welding” and “tempering” added thereto. Specifically, the existing ontology is extended by the concepts included in a file group forming the text information in a corresponding field. In the example in FIG. 5, “overlay welding” is added to “welding”, and “tempering” is added to “heat treatment”.

By using the existing ontology and results of the clustering, the noise removing unit 42 removes from the extension ontology a concept that may become noise. Specifically, the noise removing unit 42 determines the degree of similarity between the concept added to the existing ontology through the clustering and the concept included in the existing ontology and identifies the concept becoming noise by using the determined degree of similarity. The degree of similarity may be the edit distance of the character strings. In this way, the quality of the extension ontology is increased.

The noise removing unit 42 may identify the concept becoming noise by using vocabulary classification assistance information obtained through the clustering. The vocabulary classification assistance information includes at least one of an index indicating the degree of importance of the concept added to the existing ontology through the clustering and an index representing reliability of clustering results. The index indicating the degree of importance and the index representing the reliability may be determined using related art techniques. The extension ontology with the concept as noise removed therefrom is hereinafter referred to as a “refined extension ontology”. The quality of the extension ontology is thus increased in the same way as described above.

The ontology extension processing module 40 thus outputs the extension ontology equal to the existing ontology with the concept absent in the existing ontology added thereto and further outputs the refined extension ontology with the concept becoming noise removed therefrom.

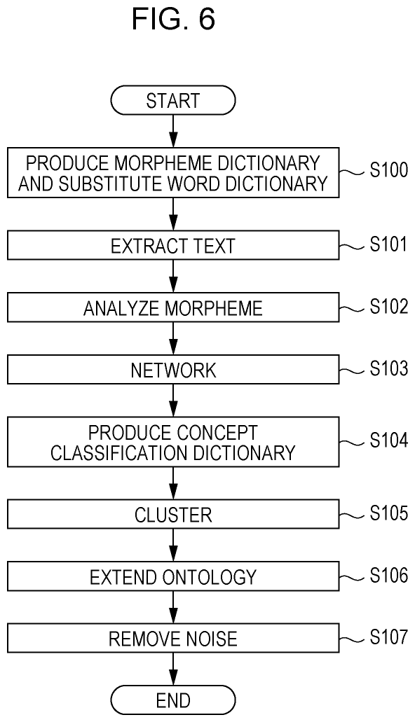

Referring to FIG. 6, the operation of the information processing apparatus 10 of the exemplary embodiment is described below.

FIG. 6 is a flowchart of an information processing program 12A of the exemplary embodiment.

When the information processing apparatus 10 is instructed to execute an ontology extension process, the CPU 11A starts up the information processing program 12A and executes steps described below.

In step 5100 in FIG. 6, the CPU 11A produces the morpheme dictionary and the substitute word dictionary from the existing ontology. Specifically, the CPU 11A produces, as the morpheme dictionary, a list of words as multiple substitute destinations (for example, concept names) and a list of words as multiple substitute sources (for example, other names) included in the existing ontology. The CPU 11A also produces, as the substitute word dictionary, a list of pairs, each pair including a word as a substitute destination and a word as a substitute source included in the existing ontology.

In step S101, the CPU 11A extracts a text from the text information. The text information includes multiple files as previously described.

In step S102, the CPU 11A morphologically analyzes the text extracted in step S101 by using the morpheme dictionary and the substitute word dictionary produced in step S100.

In step S103, the CPU 11A produces the vocabulary network in FIG. 4 from the tokenized document obtained through the morphological analysis in step S102.

In step S104, the CPU 11A produces the concept classification dictionary from the existing ontology. Specifically, as previously described, the CPU 11A produces as the concept classification dictionary a list of a concept as the inheritance source and a concept as the inheritance destination in accordance with the inheritance relation between the concepts in the existing ontology.

In step S105, the CPU 11A performs the clustering on the vocabulary network produced in step S103 by using the concept classification dictionary produced in step S104. As an example of the clustering, the clustering with network restrictions is performed. For example, the restriction is that concept names having the same inheritance source in the concept classification dictionary belong to the same cluster. The CPU 11A outputs the vocabulary classification information representing the classification of the existing ontology as the clustering results.

In step S106, the CPU 11A adds to the classification of the existing ontology a concept absent in the existing ontology as illustrated in FIG. 5 by using the vocabulary classification information obtained through the clustering in step S105. The CPU 11A thus extends the existing ontology.

In step S107, by using the existing ontology and the clustering results, the CPU 11A removes a concept becoming noise from the extension ontology obtained by extending the existing ontology in step S106. Specifically, as previously described, the CPU 11A determines the degree of similarity between the concept added to the existing ontology through the clustering and the concept in the existing ontology and identifies the concept becoming noise by using the determined degree of similarity. The CPU 11A thus outputs the refined extension ontology that is the extension ontology with the noise removed therefrom. The information processing program 12A including the series of operations is thus completed.

In accordance with the exemplary embodiment, the existing ontology is automatically extended by using the text information that is not classified as the existing ontology. The existing ontology is thus extended in a manner free from involving an increase in manpower.

In the exemplary embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the embodiment above, and may be changed.

The process in the exemplary embodiment is not only performed by a single processor but also performed by multiple processors installed in different locations in cooperation with each other. The sequential order of operations of the processor is not limited to the sequential order described above and may be appropriately modified.

The information processing apparatus of the exemplary embodiment has been described. The exemplary embodiment may be implemented in the form of a program in accordance with which a computer performs the functions of the elements in the information processing apparatus. The exemplary embodiment may be implemented in the form of a non-transitory computer readable medium.

The configuration of the information processing apparatus of the exemplary embodiment has been described for exemplary purposes and may be modified without departing from the scope of the exemplary embodiment.

The process of the program of the exemplary embodiment has also been described for exemplary purposes only. A step may be deleted from the process or a new step may be added to the process, and the sequential order of the steps may be modified without departing from the scope of the disclosure.

The process of the exemplary embodiment is performed by a software configuration when the program is executed by a computer. The disclosure is not limited to the software configuration. The exemplary embodiment may be implemented by a hardware configuration or a combination of the hardware configuration and software configuration.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor programmed to:
output, by performing clustering on vocabulary information, vocabulary classification information representing a classification of an existing ontology that is systematically represented by linking a plurality of concepts, the vocabulary information being produced from text information not classified into the existing ontology, the vocabulary information representing a semantic correlation of a vocabulary, the clustering using concept classification information that is produced in accordance with an inheritance relation between the concepts included in the existing ontology and that is indicated as a pair of a concept as an inheritance source and a concept as an inheritance destination, and
extend the existing ontology by adding to the existing ontology a concept absent in the existing ontology by using the vocabulary classification information.

2. The information processing apparatus according to claim 1, wherein the vocabulary information represents a vocabulary network that is obtained by networking the semantic correlation of the vocabulary.

3. The information processing apparatus according to claim 2, wherein the processor is programmed to:
output, by using substitute word information that is included in the existing ontology and that is indicated as a pair of a word as a substitute destination and a word as a substitute source, a document that is tokenized by morphologically analyzing a text extracted from the text information and produce the vocabulary network from the tokenized document.

4. The information processing apparatus according to claim 1, wherein the text information comprises a plurality of files and
wherein the processor is programmed to:
evaluate a degree of importance of each of the files in a relationship with the existing ontology.

5. The information processing apparatus according to claim 2, wherein the text information comprises a plurality of files and
wherein the processor is programmed to:
evaluate a degree of importance of each of the files in a relationship with the existing ontology.

6. The information processing apparatus according to claim 3, wherein the text information comprises a plurality of files and
wherein the processor is programmed to:
evaluate a degree of importance of each of the files in a relationship with the existing ontology.

7. The information processing apparatus according to claim 4, wherein the processor is programmed to:
evaluate a degree of similarity of one of the files to another of the files.

8. The information processing apparatus according to claim 5, wherein the processor is programmed to:
evaluate a degree of similarity of one of the files to another of the files.

9. The information processing apparatus according to claim 6, wherein the processor is programmed to:
evaluate a degree of similarity of one of the files to another of the files.

10. The information processing apparatus according to claim 1, wherein the text information comprises a plurality of files, and
wherein the processor is programmed to:
evaluate a degree of similarity between a word appearing in each of the files and a concept included in the existing ontology.

11. The information processing apparatus according to claim 2, wherein the text information comprises a plurality of files, and
wherein the processor is programmed to:
evaluate a degree of similarity between a word appearing in each of the files and a concept included in the existing ontology.

12. The information processing apparatus according to claim 3, wherein the text information comprises a plurality of files, and
wherein the processor is programmed to:
evaluate a degree of similarity between a word appearing in each of the files and a concept included in the existing ontology.

13. The information processing apparatus according to claim 1, wherein the processor is programmed to:
remove a concept serving as noise from the extended existing ontology by using the existing ontology and results of the clustering.

14. The information processing apparatus according to claim 2, wherein the processor is programmed to:
remove a concept serving as noise from the extended existing ontology by using the existing ontology and results of the clustering.

15. The information processing apparatus according to claim 3, wherein the processor is programmed to:
remove a concept serving as noise from the extended existing ontology by using the existing ontology and results of the clustering.

16. The information processing apparatus according to claim 4, wherein the processor is programmed to:
remove a concept serving as noise from the extended existing ontology by using the existing ontology and results of the clustering.

17. The information processing apparatus according to claim 13, wherein the processor is programmed to:
determine a degree of similarity between the concept added to the existing ontology via the clustering and a concept included in the existing ontology; and
identify the concept serving as the noise by using the determined degree of similarity.

18. The information processing apparatus according to claim 13, wherein identifying the concept serving as the noise is based on vocabulary classification assistance information that is obtained via the clustering.

19. The information processing apparatus according to claim 18, wherein the vocabulary classification assistance information comprises at least one of an index indicating a degree of importance of the concept added to the existing ontology via the clustering and an index indicating reliability of the results of the clustering.

20. A non-transitory computer readable medium storing a program causing a computer to execute a process for processing information, the process comprising:
outputting vocabulary classification information representing a classification of an existing ontology that is systematically represented by linking a plurality of concepts, by performing clustering on vocabulary information that is produced from text information not classified in the existing ontology and that represents a semantic correlation of a vocabulary, by using concept classification information that is produced in accordance with an inheritance relation between the concepts included in the existing ontology and that is indicated as a pair of a concept as an inheritance source and a concept as an inheritance destination; and
extending the existing ontology by adding to the existing ontology a concept absent in the existing ontology by using the vocabulary classification information.
